(19) United States
(12) Patent Application Publication
(10) Pub. No.: US 2011/0103819 A1
(43) Pub. Date: May 5, 2011

(54) Image forming apparatus and function display method thereof

(75) Inventor: Makoto Sekiya, Osaka (JP)

(73) Assignee: Sharp Kabushiki Kaisha, Osaka (JP)

(21) Appl. No.: 12/927,017

(22) Filed: Nov. 3, 2010

(30) Foreign Application Priority Data
Nov. 5, 2009 (JP) JP2009-253677

(51) Int. Cl. G03G 15/00

(52) U.S. Cl. 399/81

(57) ABSTRACT

An MFP (Multifunction Peripheral) transmits, when a user selects a mode, information representing the selected mode to a server. Receiving the information representing the mode from the MFP, the server reads extended functions corresponding to the received mode, forms display data for displaying the read extended function on the MFP, and transmits the formed display data to the MFP. Receiving the display data from the server, the MFP displays standard functions and displays the extended functions using the received display data, in an initial setting image for the mode selected by the user.

### CROSS-REFERENCE TO RELATED APPLICATION

This nonprovisional application claims priority under 35 U.S.C. §119(a) on Patent Application No. 2009-253677 filed in Japan on Nov. 5, 2009, the entire contents of which are hereby incorporated by reference.

### BACKGROUND OF THE INVENTION

1. Field of the Invention

The present invention relates to an image forming apparatus forming an image on a recording medium based on image data using, for example, electrophotography. More specifically, the present invention relates to a technique, in an image forming apparatus having inherent functions (standard functions) provided as standards and additionally prepared extended functions (also referred to as optional functions), of notifying the user of an extended function related to a standard function.

2. Description of the Background Art

It has become increasingly common to connect an image forming apparatus having a printer function or a copy function to a network, to allow use by a plurality of users. Further, the number of apparatuses having a plurality of modes such as a copy mode, a facsimile mode (hereinafter “facsimile” may also be denoted as FAX or fax), a network-supported printer mode and a scanner mode, such as multi-function peripherals (MFP), is increasing. In such an image forming apparatus including the MFP, each user selects one mode from the plurality of modes and sets a standard function such as duplex (two-sided) printing or collective printing (such as 2-in-1 by which two pages of an original document are printed on one sheet, or 4-in-1 by which four pages of an original document are printed on one sheet) normally provided in the image forming apparatus, whereby images are formed on sheets of paper in a desired manner. A sheet of recording paper is a typical recording medium.

When a user copies a document using an image forming apparatus as such, the user selects the copy mode, inputs image data using, for example, the scanner function, performs image processing (such as collection) by inputting various instructions through an operation panel to set a function or functions in the copy mode, and prints the results using the printer function. Such an image forming apparatus has a number of standard functions, and extended functions, which may be introduced as requested by the user, are prepared. The standard functions normally provided by the image forming apparatus are also referred to as basic functions or inherent functions. The extended functions that extend the standard functions are also referred to as optional functions or add-on functions.

Examples of such standard functions include “duplex printing,” “stapling” and “zoom” for the copy mode, and “scan-to-mail process” and “scan-to-folder process” for the scanner mode (also referred to as “fax/image transmission mode”). Examples of the extended functions include “printing of advertisement contents on a back side,” “printing English translation of Japanese text obtained by OCR processing of scanned data” and “printing of scanned data with noise removed” for the copy mode, and “FAX transmission of scanned data,” “transfer of scanned data to backbone software” and “storing text data of English translation of Japanese text obtained by OCR processing of scanned data” for the scanner mode.

Such an extended function may be realized in an image forming apparatus by the following method. Specifically, a program is prepared in a network-connected (that is, outside of the image forming apparatus) information processing apparatus (for example, a server computer), data is transmitted through the network, and data processing is done on the side of the information processing apparatus, whereby the extended function is realized. Alternatively, a program may be provided in the image forming apparatus itself, and data processing may be done by the image forming apparatus, to realize such a function. Extended functions are provided not only by the manufacturers of the image forming apparatuses but also by third vendors.

Japanese Patent Laying-Open No. 2005-275478 (hereinafter referred to as “'478 Reference”) discloses a system attaining coordination of a network-connected image forming apparatus and an apparatus external to the image forming apparatus to provide services integrating paper documents and electronic data.

The system includes an image processing apparatus and an external apparatus executing an external process. The image processing apparatus executes flow processing, based on coordination information representing a series of flow processes, in which a process related to document data and a transmitting process for transmitting an external process execution request requesting execution of an external process to be executed externally in relation to the document data, are coordinated. The image processing apparatus includes a receiving unit and a display unit. The receiving unit receives an image display data reflecting the result of execution of the external process, transmitted from the external apparatus that executed the external process in response to the external process execution request. The display unit displays an image based on the image display data received by the receiving unit. The external apparatus includes an executing unit executing the external process in response to the external process execution request transmitted from the image processing apparatus, and a transmitting unit transmitting the image display data reflecting the result of execution by the executing unit to the image processing apparatus.

The process related to the document data is executed by the external apparatus, and image display data reflecting the result of execution is received and displayed in the above-described manner, whereby services integrating paper document and electronic data can be provided.

Further, '478 Reference also discloses an approach in which a reading unit for reading an image is additionally provided in the image processing apparatus, and based on the image display data received from the external apparatus that executed the external process in accordance with an image of an instruction document read by the reading unit, an image is displayed on the display unit. In connection with such an approach, '478 Reference describes that when the image processing apparatus receives an image display program or an image display data, an image in accordance with the received program or data may always be displayed, regardless of the instruction document.

In the system disclosed in '478 Reference, the external process executed by the external apparatus is described as a service not available in the image processing apparatus, and coordination is described as establishing a relation between the services. This reference, however, is silent about the relation between the external processes (services realized by the extended functions) and the services that can originally be provided by the image processing apparatus (services realized by the standard functions).

As described above, extended functions prepared by the manufacturers of image forming apparatuses or third vendors and provided for image forming apparatuses include many useful functions that cannot be realized by the standard functions. Different from the standard functions formed only by the manufacturers of the image forming apparatuses, such extended functions are prepared by the manufacturers of image forming apparatuses or third vendors and, therefore, such functions are not displayed on a menu of the image forming apparatus. Therefore, it is difficult for a general user to know what types of functions are prepared as extended functions.

In order to solve such a problem, it may be possible to display the extended functions as a menu of the image forming apparatus. If a list of extended functions is displayed as a menu on the image forming apparatus, however, the list may highly likely include many extended functions that are not related to the function which the user wants to use (particularly when there are various and many types of extended functions). Therefore, it may be difficult to appropriately inform the user of available extended functions. In such a situation, the system disclosed in '478 Reference may be applicable.

It is noted, however, that '478 Reference does not describe at all the relation between the services realized by the extended functions (external services) and the services realized by the standard functions in the image forming apparatus. Therefore, it is difficult to appropriately inform the user of any extended function related to the user using a standard function of the image forming apparatus. Accordingly, the user cannot easily know an extended function or functions related to the user using the image forming apparatus. As a result, the user cannot utilize the image forming apparatus more conveniently using the extended functions.

### SUMMARY OF THE INVENTION

In view of the problems described above, it is desirable to provide an image forming apparatus for which extended functions are prepared in addition to standard functions, in which an extended function related to a standard function can appropriately be notified to a user, as well as to provide a method of displaying the function.

According to an aspect, the present invention provides an image forming apparatus for which a process by an extended function is prepared in addition to a standard function. The image forming apparatus includes a display unit displaying information related to a function of the image forming apparatus, and a control unit controlling the display unit such that when the standard function is displayed, an extended function related to the displayed standard function is displayed.

In the image forming apparatus, together with the standard functions normally provided in the image forming apparatus, extended functions related to the standard functions are displayed. Therefore, it is possible for a user to easily know an extended function or functions related to the user using the image forming apparatus (related to a standard function that would likely be selected by the user). As a result, the user can easily designate an extended function related to a standard function and, by using the extended function, the user can use the image forming apparatus in a more convenient manner.

Preferably, the image forming apparatus further includes a selecting unit allowing a user to select one mode from a plurality of operation modes provided in the image forming apparatus. The control unit controls the display unit such that when a standard function for the selected mode is displayed, an extended function for the selected mode is displayed.

Therefore, when the user selects a mode, the extended function or functions of the image forming apparatus related to the mode are displayed, together with the standard functions normally provided for that mode in the image forming apparatus. Accordingly, the user can easily know the extended function or functions related to the user (related to the mode selected by the user) using the image forming apparatus. As a result, the user can easily designate an extended function related to the selected mode and, by using the extended function, the user can use the image forming apparatus in a more convenient manner.

More preferably, the control unit displays a plurality of standard functions in a manner allowing user selection, and displays a plurality of extended functions in a manner allowing user selection.

When the standard functions are displayed to allow selection by the user, the extended functions can also be displayed in a manner allowing selection by the user. Therefore, the user can select desired functions from the displayed standard functions and extended functions.

More preferably, the image forming apparatus further includes a communication unit for communication with an external apparatus. The extended function is realized by the external apparatus executing a program on data transmitted from the communication unit. The external apparatus processes data received from the image forming apparatus and transmits the processed data to the image forming apparatus. The extended function is realized by the image forming apparatus receiving the processed data from the external apparatus. The external apparatus may process data received from the image forming apparatus and may transmit the processed data to an information processing apparatus other than the image forming apparatus. The extended function may be realized by the information processing apparatus receiving the processed data from the external apparatus.

By way of example, by transmitting the scanned data and the type of extended function to the external apparatus, and by the image forming apparatus or other information processing apparatus (such as a computer) receiving the data processed by the external apparatus, it is possible to realize the extended function in the image forming apparatus.

The image forming apparatus may have an additional program installed. The extended function is realized by the image forming apparatus executing the additional program.

By such an approach, by the image forming apparatus executing the additional program, it becomes possible to realize the extended function of the image forming apparatus.

Preferably, the standard function is prepared in the image forming apparatus at a stage of shipment of the image forming apparatus. The extended function is prepared in the image forming apparatus at a stage later than shipment of the image forming apparatus.

The standard function is provided at the stage of shipment of the image forming apparatus from the manufacturer. The extended function is provided for the image forming apparatus that already has the standard function or functions, by a process (such as installation of a program) performed after shipment from the manufacturer. The extended function added to the standard functions by such a subsequent process can be displayed together with the related standard function.

More preferably, the display unit includes a pressure-sensitive display divided beforehand to at least three areas including first, second and third areas, for displaying a pressure-sensitive selection button in each area. The control unit displays selection buttons allowing the user to select one mode from a plurality of operation modes provided in the image forming apparatus in the first area. The control unit displays selection buttons allowing the user to select, in response to mode selection by the user in the first area, a standard function for the selected mode in the second area. Further, the control unit displays selection buttons allowing the user to select, in response to mode selection by the user in the first area, an extended function for the selected mode in the third area.

In response to the selection by the user of a mode using the selection buttons displayed on the first area, selection buttons allowing the user to select the standard function are displayed on the second area, and selection buttons allowing the user to select the extended function are displayed on the third area. Since the standard functions displayed on the second area are related to the extended functions displayed on the third area, it is possible for a user to easily know an extended function or functions related to the user using the image forming apparatus (related to a standard function that would likely be selected by the user).

The control unit may display, in response to selection of any of the standard functions and the extended functions by the user, a setting image for the selected function in a predetermined area of the pressure-sensitive display. Further, the control unit may display the selection buttons in the form of a hierarchical menu, in a predetermined area.

Simply by an operation only in the predetermined area, the user can set items related to the selected function. The function or functions can be selected simply by operating selection buttons displayed in the form of a hierarchical menu.

According to another aspect, the present invention provides a function display method for an image forming apparatus for which an extended function added to a standard function is prepared, and having a display unit. The function display method includes the steps of displaying information related to a function of the image forming apparatus on the display unit; and displaying, when the standard function is displayed on the display unit, an extended function related to the displayed standard function on the display unit.

The image forming apparatus may further include a selecting unit. The method further includes the step of detecting selection of one mode from a plurality of operation modes provided in the image forming apparatus through the selecting unit, and at the step of displaying the extended function on the display unit, a standard function for the selected mode and an extended function for the selected mode are displayed.

At the step of displaying the extended function on the display unit, the standard functions and the extended functions may be displayed in a manner allowing user selection.

Preferably, the image forming apparatus further includes a communication unit for communication with an external apparatus. The function display method further includes the step of transmitting information representing an extended function selected by the user and object data to be processed by the extended function to the external apparatus through the communication unit. The extended function is realized by the external apparatus executing a program corresponding to the information on the object data.

The function display method may further include the step of receiving data generated by execution of the program on the object data, from the external apparatus.

More preferably, the image forming apparatus may have an additional program installed. The method further includes the step of realizing the extended function by executing the additional program.

The standard function is prepared in the image forming apparatus at a stage of shipment of the image forming apparatus. The extended function is prepared in the image forming apparatus at a stage later than shipment of the image forming apparatus.

More preferably, the display unit includes a pressure-sensitive display divided beforehand to at least three areas including first, second and third areas, for displaying a pressure-sensitive selection button in each area. The method further includes the steps of displaying selection buttons allowing the user to select one mode from a plurality of operation modes provided in the image forming apparatus in the first area; displaying selection buttons allowing the user to select, in response to mode selection by the user in the first area, a standard function for the selected mode in the second area; and displaying selection buttons allowing the user to select, in response to mode selection by the user in the first area, an extended function for the selected mode in the third area.

By the image forming apparatus and the function display method thereof in accordance with the present invention, in the image forming apparatus for which extended functions (optional functions) are prepared in addition to the standard functions, it is possible to appropriately notify the user of the extended function or functions related to the standard function.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an overall configuration of the network image forming system in accordance with an embodiment of the present invention.

FIG. 2 is a block diagram schematically showing hardware configuration of a computer shown in FIG. 1.

FIG. 3 is a block diagram schematically showing hardware configuration of an MFP shown in FIG. 1.

FIG. 4 shows an extended functions management table in the MFP of FIG. 1.

FIG. 5 is a flowchart representing a control structure of a process program executed by the server computer and the MFP shown in FIG. 1.

FIGS. 6 and 7 show exemplary displays on the touch-panel of the MFP when the program of FIG. 5 is executed.

### DESCRIPTION OF THE PREFERRED EMBODIMENTS

In the following description and in the drawings, the same components are denoted by the same reference characters and same names. Their functions are also the same. Therefore, detailed description thereof will not be repeated. In the following, description will be given assuming that extended functions other than the standard functions (functions provided at the time of shipment from the manufacturer or the like of the image forming apparatus) normally provided in the image forming apparatus in accordance with the present invention are realized by a server computer (hereinafter, in the description and drawings, also simply referred to as a “server”). As will be described as modifications later, an extended function realized by the server computer may be provided in the image forming apparatus itself, by an operation conducted after shipment from the manufacturer of the image forming apparatus.

Regardless of the method of realization, such an extended function may be considered as an extended function customized for the image forming apparatus, which is either an extended function prepared in the server computer and realized by the server computer or an extended function prepared by subsequent operation and realized by the image forming apparatus. Further, these methods of realization may be combined. Specifically, some of the extended functions may be prepared in the server computer, and others may be realized by the subsequent operation in the image forming apparatus. In the present invention, the types of extended functions and the methods of realizing the extended functions are not limited, as long as the extended function is prepared as a function added subsequently (add-on function) to the standard function.

Further, in the following, the image forming apparatus in accordance with the present invention will be described as an MFP having a plurality of modes. The present invention, however, is not limited to an MFP and it may be any apparatus that forms an image on a sheet of recording paper. For instance, an image forming apparatus having the printer mode only (that is, a printing device (printer)), or an image forming apparatus having the image communication mode only (that is, a facsimile machine (having the scanning function and print function)) may also be the image forming apparatus in accordance with the present invention.

[Overall System Configuration]

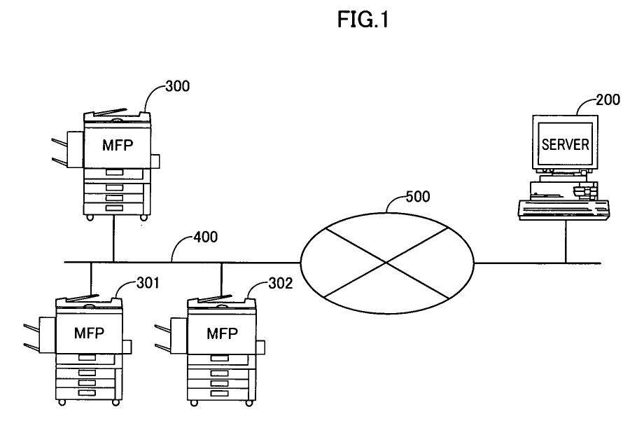

Referring to FIG. 1, the network image forming system in accordance with the present embodiment includes a plurality of MFPs 300 to 302, and a server computer 200 external to the MFPs 300 to 302. The number of MFPs is not limited to three. Each MFP transmits the mode of MFP selected by the user to the server computer, and displays an extended menu image received from the server computer. Server computer 200 transmits the display data for displaying the extended menu to MFPs 300 to 302, realizes the selected extended function based on the data (image data) received from MFPs 300 to 302, and transmits the result to MFPs 300 to 302. The display data may be HTML (Hyper Text Markup Language) data, if MFP 300, for example, has the browser function.

Server computer 200 and MFPs 300 to 302 are connected to be communicable with each other by a network line (LAN: Local Area Network) 400 and the Internet 500. Though MFPs 300 to 302 are denoted by different reference characters, they may have the same standard functions. The Internet 500 may be an intranet. It is noted that a (client) computer that transmits the print data to MFPs 300 to 302 is not shown in the figure.

In the present embodiment, server computer 200 receives information indicating the mode selected by the user in one of the MFPs 300 to 302, for example, MFP 300, through network line 400 and the Internet 500, together with MFP identification (ID) information uniquely identifying the MFP 300, from MFP 300. Server computer 200 transmits the HTML data for displaying the extended functions menu related to the mode selected by the user on MFP 300, to MFP 300 through network line 400 and the Internet 500. Based on the HTML data received from server computer 200, MFP 300 displays the extended functions menu related to the mode selected by the user based on the HTML data received from server computer 200, together with the standard functions menu, on the touch-panel display.

As described above, in the present embodiment, extended functions related to the mode selected by the user using MFP 300 are displayed on the touch-panel display, together with the standard functions of the selected mode. The extended functions related to the mode selected by the user refer to the functions that facilitate use of MFP 300 in the mode selected by the user when the extended functions are used. The relation between the standard functions and the extended functions may be established directly as will be described in the modification, not by means of the mode.

[Hardware Configuration]

<Server Computer 200>

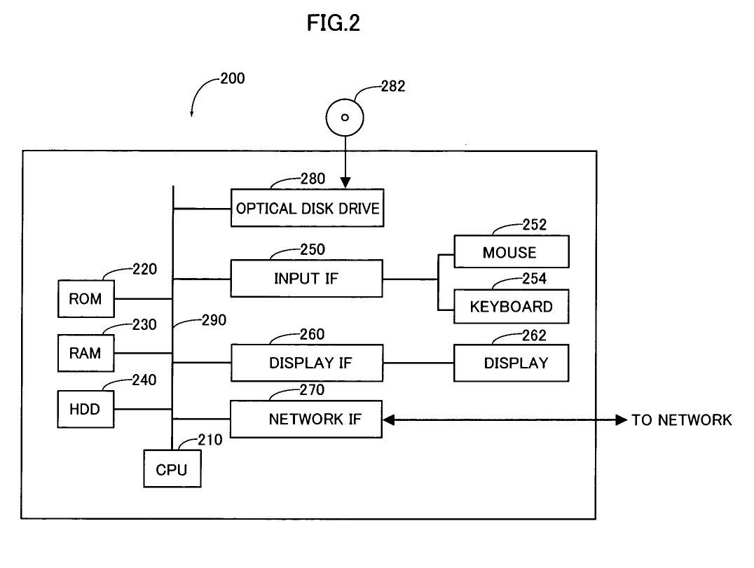

Referring to FIG. 2, server computer 200 includes: a bus 290; a CPU (Central Processing Unit) 210; an ROM (Read Only Memory) 220; an RAM (Random Access Memory) 230; a hard disk drive (HDD) 240; an optical disk drive 280; an input interface 250; a display interface 260; and a network interface (hereinafter referred to as “network IF”) 270 providing wired connection to network line 400. On optical disk drive 280, an optical disk 282 is mounted, enabling writing of information to optical disk 282 and reading of information from optical disk 282. Input interface IF (hereinafter referred to as “input IF” and “interface” will be denoted by “IF”) 250 is an interface to a mouse 252 and a keyboard 254. Display interface (hereinafter referred to as “display IF”) 260 is an interface to a display 262. CPU 210, ROM 220, RAM 230, HDD 240, optical disk drive 280, input IF 250, display IF 260 and network IF 270 are connected to bus 290. Server computer 200 may include a magnetic disk drive on which a magnetic disk is mountable, and capable of writing of information to the magnetic disk and reading of information from the magnetic disk, in place of/in addition to optical disk drive 280.

Bus 290, ROM 220, RAM 230, HDD 240, optical disk drive 280, input IF 250, display IF 260 and network IF 270 all operate in cooperation with each other under the control of CPU 210, and as the external apparatus in accordance with the present invention, server computer 200 realizes processes of various applications. For instance, by an application, when information representing the mode selected by the user in MFP 300 is received from MFP 300, a table managing the extended functions of MFP 300 (hereinafter referred to as “extended functions management table”) is looked up, and data (HTML data) for displaying the extended functions menu related to the mode selected by the user with the standard functions menu in MFP 300 are formed and transmitted to MFP 300. Further, by another application, using the information representing the extended function selected by the user in MFP 300 and the scanned data received from MFP 300, a program corresponding to the selected extended function is executed and thereby processed data is formed, and the formed processed data is transmitted to MFP 300 or to an information processing apparatus (computer) other than MFP 300.

The computer program or programs causing server computer 200 to operate as the external apparatus of the network image forming system in accordance with the present embodiment are stored in optical disk 282 to be inserted to optical disk drive 280, and transferred from optical disk 282 to HDD 240. Alternatively, the programs may be transmitted through network line 400 to server computer 200 and stored in HDD 240. At the time of execution, the programs are loaded to RAM 230. The programs may be directly loaded to RAM 230 from optical disk 282 or through network line 400.

These programs include a plurality of instructions causing server computer 200 to operate as the external apparatus in the network image forming system in accordance with the present embodiment. Some of the basic functions necessary to realize these operations are provided by an operating system (OS) operating on server computer 200 or a third-party program, or a module of various tool kits installed in server computer 200. Therefore, the program may not necessarily include all functions required to realize the method and system in accordance with the present embodiment. The program may include only the instructions executing a prescribed process as server computer 200 described above, by calling appropriate functions or “tools” in a controlled manner to attain the desired results. General operations of a computer as the substance of server computer 200 are well known and, therefore, description will not be given here.

<MFP 300>

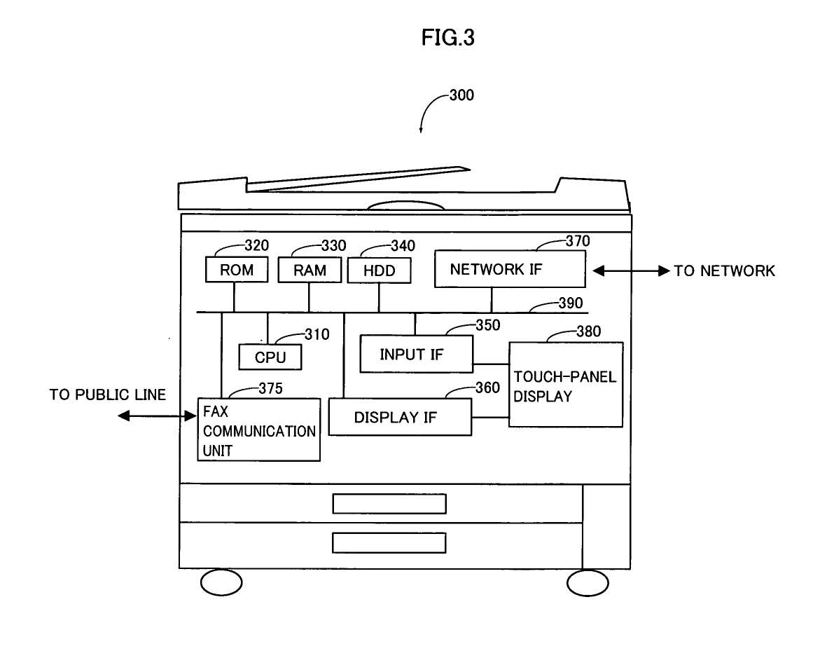

Referring to FIG. 3, MFP 300 includes: a bus 390; a CPU 310; an ROM 320; an RAM 330; a hard disk drive (HDD) 340, an input IF 350 and a display IF 360 as an interface to a touch-panel display 380; a network IF 370 providing wired connection to network line 400; and a FAX communication unit 375 providing connection to a public line. CPU 310, ROM 320, RAM 330, HDD 340, input IF 350, display IF 360, network IF 370 and FAX communication unit 375 are connected to bus 390. Though not shown in FIG. 3, MFP 300 includes hardware buttons such as a start button and ten-key buttons.

Touch-panel display 380 of MFP 300 displays a menu of basic functions to the user. The user selects a mode or function and inputs contents (for example, the value of magnification) of items to be set for the selected function, through touch-panel display 380. MFP 300 has a browser function for displaying the data (HTML data) received from server computer 200 on touch-panel display 380. By the browser function, the standard functions menu for the mode selected by the user and the extended functions menu related to the mode selected by the user are displayed on touch-panel display 380.

If the user selects an extended function in MFP 300, MFP 300 transmits, for example, a piece of information indicating the type of selected extended function and the scanned data to server computer 200. Then, MFP receives the result of processing of the extended function (processed data) from server computer 200, and executes the process corresponding to the extended function. Specific examples of extended functions will be described later.

Bus 390, ROM 320, RAM 330, HDD 340, input IF 350, display IF 360, network IF 370 and FAX communication unit 375 all operate in cooperation with each other under the control of CPU 310, and realize the printing process, FAX transmission/reception process, scanner process and copy process in MFP 300. These processes are executed by various components forming MFP 300, not shown in FIG. 3, under the control of CPU 310.

The image communication mode of MFP 300 includes the facsimile communication mode of transmitting/receiving image data using public line through FAX communication unit 375, the Internet facsimile transmission mode of transmitting/receiving image data using the Internet connection through network IF 370, the electronic mail transmission mode of transmitting/receiving image data attached to an electronic mail (scan-to-mail: provided as a standard function), and an image transfer mode (scan-to-folder: provided as a standard function) of transferring image data to a specific folder using network line 400.

MFP 300 includes, for example, a document reading unit (scanner unit), an image forming unit, a paper feed unit, and a paper discharge unit. In MFP 300, on image data of an original document read by the document reading unit, various image processing operations are done by CPU 310, and the resulting image data is output to the image forming unit. MFP 300 includes a so-called laser type (electrophotographic type) printing function, in which a laser beam is used for exposure. It may have a different type printing function.

MFP 300 has, as its operation modes, copy mode, facsimile mode (on the exemplary image of touch-panel display, shown as “FAX/IMAGE TRANSMISSION MODE”), printer mode and scanner mode (on the exemplary image of touch-panel display, shown as “DOCUMENT FILING MODE”). In the following, these operation modes will be described.

—Facsimile Mode—

In the following, the operation in the facsimile mode (also referred to as a facsimile/image transmission mode) will be described. The transmitting operation in the facsimile mode is realized mainly by the operations of the document reading unit (scanner unit) and FAX communication unit 375, and the receiving operation is realized mainly by the operations of FAX communication unit 375 and the image forming unit.

The transmitting operation is as follows. As an example, transmission from MFP 300 to MFP 301 will be described. In MFP 300, when the facsimile mode is designated, a document placed on a platen is read by a document reading unit as image data. The read image data is input to CPU 310. The image data is subjected to various image processing operations using various functions by CPU 310. The processed image data is output to FAX communication unit 375. FAX communication unit 375 on the transmitting side MFP 300 connects a designated transmitting side line to a designated transmission destination. The FAX communication unit 375 converts the image data to communication data in accordance with facsimile transmission standard, and transmits the same to a receiving side facsimile apparatus (for example, an MFP 301 having the facsimile communication function). When the line is connected, FAX communication unit of the receiving side MFP 301 detects a communication request signal from FAX communication unit 375 of the transmitting side MFP 300, and transmits an acknowledgement signal. Thereafter, these two FAX communication units pass performance information provided in the transmitting side and the receiving side, respectively, determine the highest possible communication speed available, and coding/code correction method of image data, and set modem communication method. Using image signal format in accordance with the determined communication method, data is transmitted from FAX communication unit 375 of the transmitting side MFP 300 to FAX communication unit of the receiving side MFP 301. When transmission ends, the line is disconnected.

The receiving operation is as follows. The FAX communication unit on the receiving side MFP 301 converts the received data to image data, and transmits the same to the image forming unit. The received data may be converted to the image data by the image forming unit. The image forming unit prints the document image represented by the image data converted from the received data on a sheet of recording paper, as in the image forming operation in the copy mode.

—Copy Mode—

In the following, the image forming operation in the copy mode will be described. The image forming unit prints an image represented by the image data read by the document reading unit and subjected to image processing by various functions, on a sheet of recording paper. The image forming unit includes, by way of example, a photoreceptor drum, a charger, a laser scanning unit, a developer, a transfer device, a cleaning device, a fixing device and a neutralizer.

In the image forming unit, a feeding path, for example, is formed, and a sheet of recording paper fed from the paper feed unit is fed along the feeding path. The paper feed unit draws out sheets of recording paper stacked on a paper feed cassette or on a manual feed tray one by one, and feeds the sheet of paper to the feeding path of the image forming unit.

While the sheet of recording paper is fed along the feeding path of image forming unit, the sheet passes between the photoreceptor drum and the transfer device, and further passes through the fixing device, whereby printing is done on the sheet of recording paper.

The photoreceptor drum rotates in one direction, and its surface is cleaned by the cleaning device and the neutralizer and, thereafter, uniformly charged by the charger. The laser scanning unit modulates the laser beam based on the image data to be printed, and repeatedly scans the surface of photoreceptor drum with the laser beam in a main scanning direction, whereby an electrostatic latent image is formed on the surface of photoreceptor drum. The developer develops the electrostatic latent image by supplying toner to the surface of photoreceptor drum, and thus, a toner image is formed on the surface of photoreceptor drum.

The transfer device transfers the toner image on the surface of photoreceptor drum to the sheet of recording paper passing between the transfer device and the photoreceptor drum. The fixing device includes a heating roller for heating the sheet of recording paper and the pressure roller for pressing the sheet of recording paper. Since the sheet of recording paper is heated by the heating roller and pressed by the pressure roller, the toner image that has been transferred to the sheet of recording paper is fixed on the sheet. The sheet of recording paper discharged from the fixing device (printed paper) is discharged to the discharge tray.

—Printer Mode—

In the following, the operation in the printer mode will be described. In the printer mode, the print function is realized mainly by the operation of the image forming unit.

When MFP 300 receives print data from a (client) computer through network IF 370, it converts the received print data to image data, and transmits the converted data to the image forming unit. The print data may be converted to the image data by the image forming unit. The image forming unit prints the document image represented by the image data converted from the print data on a sheet of recording paper, as in the image forming operation in the copy mode described above.

—Scanner Mode—

In the following, the operation in the scanner mode will be described. In the scanner mode, the scanning function is realized mainly by the operation of the document reading unit (scanner unit).

In MFP 300, a document placed on a platen is read as image data by the document reading unit. The read image data is input to CPU 310, where the image data is subjected to image processing operations based on various functions by CPU 310. The processed image data is output to a sheet of recording paper in the copy mode, or the image data is transmitted in the facsimile transmission mode, the Internet facsimile mode or the electronic mail communication mode (scan-to-mail). Alternatively, the processed image data is stored in HDD 340 or transmitted to a computer connected to a network, through network IF 370, in the image transfer mode (scan-to-folder).

[Configuration of Extended Functions Management Table]

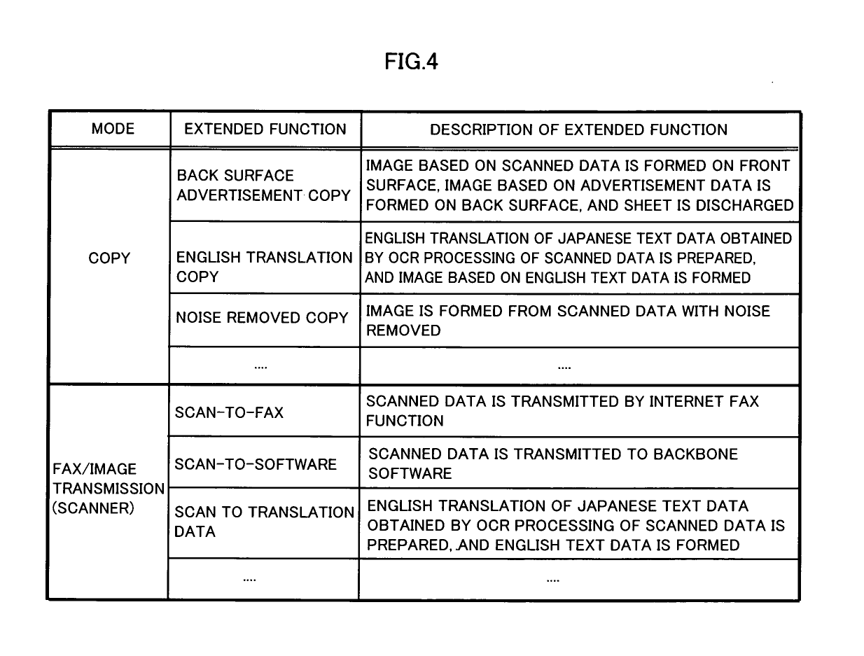

Referring to FIG. 4, the extended functions management table storing extended functions that can be realized by server computer 200 for the mode selected by the user in MFP 300 will be described. FIG. 4 shows, in the form of a table, the modes of MFP 300 and the extended functions related to the modes. The extended functions management table is stored in HDD 240 of server computer 200. The column of extended function description is for the convenience of description of the present embodiment and it is not stored in HDD 240.

The modes shown in the extended functions management table of FIG. 4 correspond to the modes that can be selected by the user in MFPs 300 to 302 shown in FIG. 1. Specifically, the modes are, among the copy mode, facsimile mode (fax/image transmission mode), printer mode and scanner mode (document filing mode), three modes other than the “printer mode” that cannot be selected by the user using touch-panel display 380.

FIG. 4 is an extended functions management table showing an example of the copy mode and the fax/image transmission mode among these modes. As shown in FIG. 4, in the extended functions management table, back surface advertisement copy function, English translation copy function, noise removed copy function and the like are stored as extended functions related to the copy mode. In the extended functions management table, scan-to-fax function, scan-to-software function, scan-to-translation data function and the like are stored as extended functions related to the fax/image transmission mode. These extended functions are examples, and the functions are not limited to the above.

In the following, the extended functions will be briefly described. The extended functions are not limited to those described below.

The back surface advertisement copy function refers to the extended function as described below. Specifically, data obtained by scanning a document in MFP 300 (scanned data) is transmitted to server computer 200. Server computer 200 transmits image data (processed data) incorporating advertisement data to MFP 300. MFP 300 forms an image based on the scanned data on a front surface of a sheet of recording paper, and forms an image based on the advertisement data on the back surface of the sheet of recording paper. Alternatively, the extended function may be as follows: server computer 200 forms image data (processed data) having the advertisement data inserted to the data (scanned data) received from MFP 300 and transmits the resulting data to MFP 300, and MFP forms an image with the advertisement based on the received image data (processed data) on a sheet of recording paper.

The English translation copy function refers to the extended function as described below. Specifically, scanned data obtained by scanning a document in MFP 300 is transmitted to server computer 200. Server computer 200 performs OCR processing on the received scanned data to form Japanese text data. Server computer 200 translates the formed Japanese text data to English to form English text data (processed data), and transmits the resulting data to MFP 300. MFP 300 forms an image based on the received English text data (processed data) on a sheet of recording paper.

The noise removed copy function refers to the extended function as described below. Specifically, scanned data obtained by scanning a document in MFP 300 is transmitted to server computer 200. Server computer 200 extracts noise from the received scanned data, forms image data (processed data) with the extracted noise removed, and transmits the resulting data to MFP 300. MFP 300 forms an image based on the received noise-removed data (processed data) on a sheet of recording paper.

The scan-to-fax function refers to the extended function as described below. Specifically, scanned data obtained by scanning a document in MFP 300 is transmitted to server computer 200. Server computer 200 transmits the scanned data using the Internet FAX function. The scan-to-fax function may also include the following extended function. Specifically, server computer 200 converts the received scanned data to an Internet fax format (processed data), and transmits the resulting data to MFP 300. MFP 300 transmits an image based on the received processed data by facsimile.

The scan-to-software function refers to the extended function as described below. Specifically, scanned data obtained by scanning a document in MFP 300 is transmitted to server computer 200. Server computer 200 transfers the scanned data to backbone software executed by server computer 200 (or it may transfer the data to a different computer that executes such software).

The scan-to-translation data function refers to the extended function as described below. Specifically, scanned data obtained by scanning a document in MFP 300 is transmitted to server computer 200. Server computer 200 performs OCR processing on the received scanned data to form Japanese text data. Server computer 200 translates the formed Japanese text data to English to form English text data (processed data). Server computer 200 transmits the resulting English text data to MFP 300. MFP 300 receives the English text data (processed data). The English text data received by MFP 300 is processed by a standard function or the like of MFP 300.

[Software Configuration]

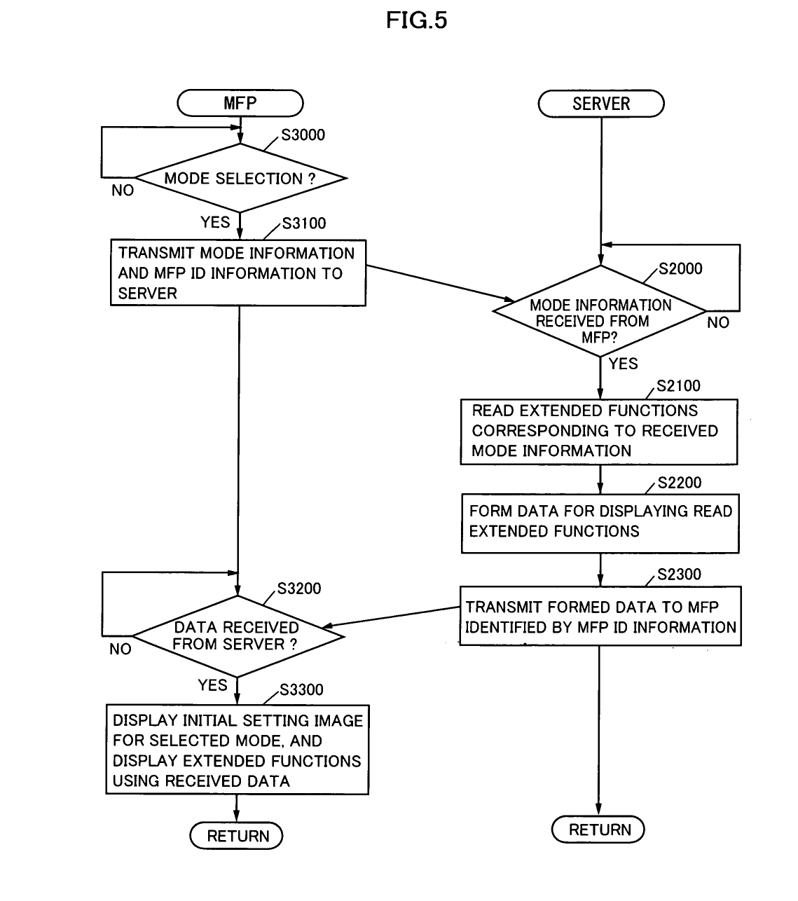

Referring to FIG. 5, a control structure of a computer program executed by server computer 200 and MFP 300 in order to display the extended functions menu prepared in advance for MFP 300 on touch-panel display 380 will be described. The contents of extended functions mentioned above (functions of forming processed data in server computer 200 and returning the data to MFP 300 or functions of transferring the data processed by sever computer 200 to a computer or the like other than MFP 300) are not shown in FIG. 5.

The program having the control structure shown on the left side of FIG. 5 is executed by CPU 310 of MFP 300. At S3000 (hereinafter the letter “S” represents “step”), CPU 310 of MFP 300 (hereinafter simply referred to as CPU 310) determines whether or not the user using MFP 300 has selected a mode (any of the copy mode, fax/image transmission mode and document filing mode). In the initial image displayed on touch-panel display 380 of MFP 300, when the user presses any of “COPY” button, “FAX/IMAGE TRANSMISSION” button and “DOCUMENT FILING” button, of which one can be selected, it is determined that the corresponding mode is selected by the user. If CPU 310 determines that the user has selected a mode (YES at S3000), the process proceeds to S3100. Otherwise (NO at S3000), CPU 310 repeats the process of S3000 until it is determined that the user using MFP 300 has selected a mode.

At S3100, CPU 310 transmits information indicating the mode selected by the user and MFP identifying information to server computer 200.

At S3200, CPU 310 determines whether or not data (display data) is received from server computer 200. If CPU 310 determines that the data (display data) is received from server computer 200 (YES at S3200), the process proceeds to S3300. Otherwise (NO at S3200), CPU 310 repeats the process of S3200 until the data (display data) is received from server computer 200.

At S3300, CPU 310 displays a list of standard functions (standard functions menu) in the initial setting image of the selected mode, and displays a list of extended functions (extended functions menu) using the data (display data) received from server computer 200. At this time, both the standard functions menu and the extended functions menu are displayed in the form of selectable buttons on touch-panel display 380.

The program having the control structure shown on the right side of FIG. 5 is executed by CPU 210 of server computer 200. At S2000, CPU 210 of server computer 200 (hereinafter simply referred to as CPU 210) determines whether or not information representing the mode selected by the user is received from MFP 300. Since there are a plurality of MFPs from which the modes are received, server computer 200 also receives MFP identifying information from MFP 300. If CPU 210 determines that the information representing the mode selected by the user is received from MFP 300 (YES at S2000), the process proceeds to S2100. Otherwise (NO at S2000), CPU 210 repeats the process of S2000 until it is determined that the information representing the mode selected by the user is received from MFP 300.

At S2100, using the information representing the mode received from MFP 300, CPU 210 reads the extended functions corresponding to the mode identified by the received information representing the mode, from the extended functions management table shown in FIG. 4. As described above, the extended functions management table is stored in HDD 240 of server computer 200.

At S2200, CPU 210 forms display data (data in the HTML format or the like) for displaying the extended functions read from extended functions management table of HDD 240, on touch-panel display 380 of MFP 300.

At S2300, CPU 210 transmits the formed display data (data in the HTML format or the like) to MFP 300 identified by the MFP identifying information.

The following process may be added to the flowchart shown in FIG. 5. Specifically, if the display data for displaying the extended functions is not received from server computer 200 within a predetermined time period from transmission (S3100) of the information representing the mode selected by the user from MFP 300 to server computer 200, only the standard functions of MFP 300 may be displayed together with an indication of time out error, on touch-panel display 380 of MFP 300.

[Operation]

The operation of the network image forming system in accordance with the present embodiment based on the structure and flowchart as above will be described in the following.

In MFP 300, every time a user selects a mode of MFP 300 (YES at S3000), MFP 300 transmits the information representing the mode selected by the user, together with the MFP identification information for identifying MFP 300, to server computer 200 (S3100).

Every time the information representing the mode selected by the user in MFP 300 is received (YES at S2000), server computer 200 reads extended functions corresponding to the received information representing the mode, from the extended functions management table shown in FIG. 4 (S2100).

Server computer 200 forms display data for displaying the read extended functions on touch-panel display 380 of MFP 300 (S2200). Server computer 200 transmits the formed display data to MFP 300 identified by the MFP identifying information (S2300).

Receiving the display data from server computer 200 (YES at S3200), MFP 300 displays the list of standard functions (standard functions menu) and the list of extended functions (extended functions menu) using the data (display data) received from server computer 200, in the initial setting image of the mode selected by the user, on touch-panel display 380 (S3300).

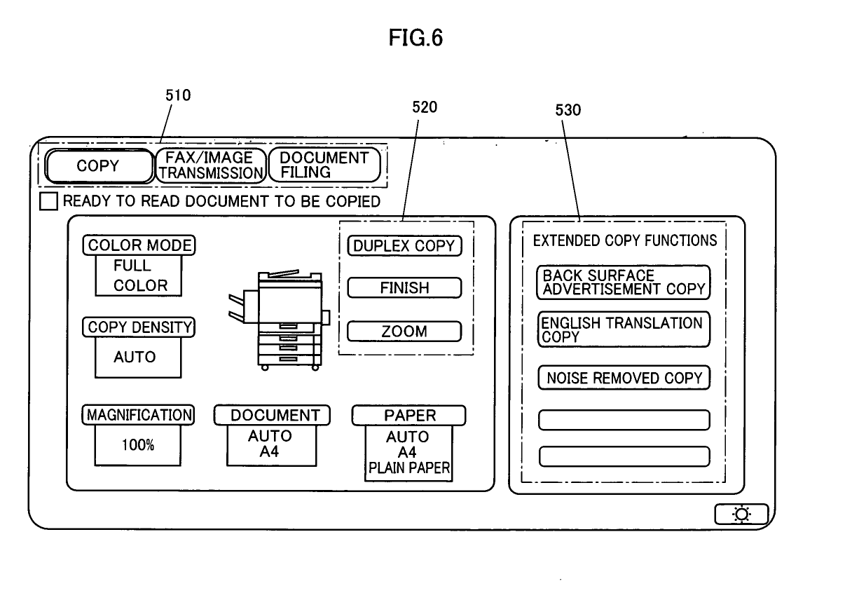

FIG. 6 shows an image displayed as a result of the process below. Specifically, the user pressed “COPY” button on the initial image of MFP 300 (YES at S3000), and in response, MFP 300 transmitted the information representing the copy mode selected by the user, to server computer 200 (S3100). In FIG. 6, the area on which the mode selection buttons (“COPY” button, “FAX/IMAGE TRANSMISSION” button and “DOCUMENT FILING” button) are displayed in a manner allowing user selection is the first area 510.

Server computer 200 read “back surface copy function,” “English translation copy function” and “noise removed copy function” as the extended functions corresponding to the copy mode selected by the user in MFP 300, from the extended functions management table shown in FIG. 4 (S2100). Server computer 200 formed the display data for displaying the read extended functions on touch-panel display 380 of MFP 300 (S2200), and transmitted the formed display data to MFP 300 (S2300).

Since the display data was received from server computer 200 (YES at S3200), MFP 300 displayed the list of standard functions (standard copy functions menu) of the copy mode selected by the user, on the left side (second area 520) of touch-panel display 380 as shown in FIG. 6. In addition, MFP 300 displayed the list of extended functions (extended copy functions menu) using the data (display data) received from server computer 200, on the right side (third area 530) of touch-panel display 380 as shown in FIG. 6 (S3300).

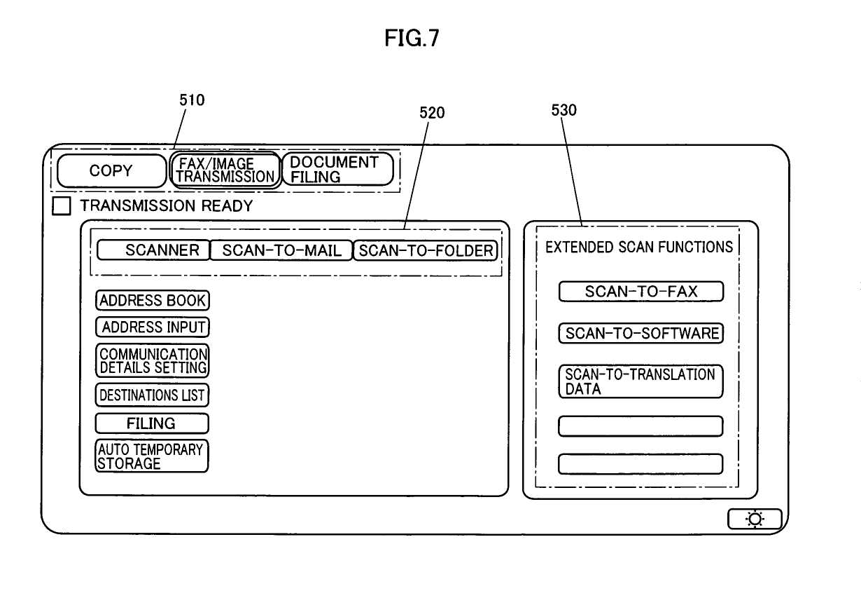

FIG. 7 shows an image displayed as a result of the process below. Specifically, the user pressed “FAX/IMAGE TRANSMISSION” button on the initial image of MFP 300 (YES at S3000), and in response, MFP 300 transmitted the information representing the fax/image transmission mode selected by the user, to server computer 200 (S3100). In FIG. 7, as in FIG. 6, the area on which the mode selection buttons (“COPY” button, “FAX/IMAGE TRANSMISSION” button and “DOCUMENT FILING” button) are displayed in a manner allowing user selection is the first area 510.

Server computer 200 read “scan-to-fax function,” “scan-to-software function” and “scan-to-translation data function” as the extended functions corresponding to the fax/image transmission mode selected by the user in MFP 300, from the extended functions management table shown in FIG. 4 (S2100). Server computer 200 formed the display data for displaying the read extended functions on touch-panel display 380 of MFP 300 (S2200), and transmitted the formed display data to MFP 300 (S2300).

Since the display data was received from server computer 200 (YES at S3200), MFP 300 displayed the list of standard functions (standard scan functions menu) of the fax/image transmission mode selected by the user, on touch-panel display 380, on the left side (second area 520) of touch-panel display as shown in FIG. 7. In addition, MFP 300 displayed the list of extended functions (extended scan functions menu) using the data (display data) received from server computer 200, on the right side (third area 530) of touch-panel display 380 as shown in FIG. 7 (S3300).

In this manner, the standard functions in the mode of MFP selected by the user and the extended functions related to the mode are displayed on one image on touch-panel display 380.

As shown in FIGS. 6 and 7, the information (mode selection buttons) displayed in the first area 510 is the same regardless of the type of selected mode. In the second area 520, the standard functions menu for the selected mode is displayed in a manner allowing user selection. In the third area 530, the extended functions menu for the selected mode (menu of extended functions related to the standard function) is displayed in a manner allowing user selection. In this manner, in each of the three areas divided in advance, selection buttons of the same type (mode selection, standard function selection and extended function selection) are displayed, regardless of mode switching. Specifically, in the first area 510, the mode selection buttons are displayed, in the second area 520, standard function selection buttons are displayed, and in the third area 530, extended function selection buttons are displayed. Since the selection buttons of the same type (category) are displayed in the same area even when the user switches the mode, confusion by the user can be avoided, and a user-friendly interface is formed.

Further, if any of the functions of the standard functions menu displayed in the second area 520 and any of the functions of the extended functions menu displayed in the third area 530 are selected by the user, the display image is switched to enable the user to input contents for setting items (for example, numerical value for magnification) related to the selected function, as needed. The selection of a function by the user and the input of setting items by the user can be displayed in the form of a hierarchical menu.

As described above, in the network image forming system in accordance with the present embodiment, when a mode is selected, functions normally provided in the MFP for the mode (standard functions) as well as functions (extended functions) subsequently provided in the MFP for the mode can be displayed on one image. Therefore, it is possible for the user to easily know the extended function or functions related to the user using the MFP (related to the mode selected by the user). As a result, the user can easily designate an extended function or functions related to the selected mode, and by using the extended function or functions, he/she can use the MFP in a more convenient manner.

<Modification>

In the embodiment described above, the server computer functions as an external apparatus, and the extended functions related to the mode selected by the user are displayed on the touch-panel display together with the standard functions of the selected mode. The present invention, however, may be configured such that the extended functions realized by the server computer are realized in the image forming apparatus (MFP) itself, as will be described in the modification below. It is noted, however, that the image forming apparatus has an extended function (add-on function) provided by an operation performed after shipment from the manufacturer or related operator of the image forming apparatus. Similar to the extended functions in the embodiment above, the extended functions in the present modification are also distinguished from the standard functions.

Specifically, the extended functions other than the standard functions normally provided in the MFP in accordance with the present modification are realized by the following method, not by the server computer connected to the network.

An MFP having the same standard functions as the MFP described in the embodiment above is shipped from the manufacturer of the MFP. After shipment, a subsequent operation or operations may be done. By way of example, a storage device (optional ROM) storing an extended function program may be mounted on a control board of the MFP, an extended control board (optional board) may be added to the MFP, or an optional program may be installed in the HDD of the MFP.

When the program stored in the optional ROM, the program executed by the optional board or the optional program installed in the HDD of the MFP is executed, the extended function (back surface advertising copy function, English translation copy function, noise removed copy function, scan-to-fax function, scan-to-software function, scan-to-translation data function or the like) of the MFP is realized. The optional program realizing such an extended function may be executed on an API (Application Program Interface) build on the platform (OS) on which the software realizing the basic functions of the MFP runs.

In the present modification, the extended functions management table shown in FIG. 4 is stored in the HDD of the MFP. In the extended functions management table, only the extended functions that can be realized by the MFP (only those that can be realized by the add-on program) are stored.

Further, in the present modification, the processes of S2100 and S2200 of the flowchart shown in FIG. 5 are executed by the MFP. Further, since no communication with the server computer takes place, the processes of S3100 and S3200 as well as S2000 and S2300 are not executed.

Specifically, as a process corresponding to the process of S2100, the MFP in accordance with the present modification executes the process of reading the extended functions corresponding to the selected mode. Thereafter, the MFP executes the process of S2200. After the process of S2200, as a process corresponding to the process of S3300, the MFP executes the process of displaying the list of standard functions (standard functions menu) and displaying the list of extended functions (extended functions menu) using the data (display data) formed in the MFP, in the initial setting image of the selected mode.

As described above, in the present modification, the extended function or functions are executed in the MFP itself. Therefore, even when there is no server computer (external apparatus), it is possible to display the standard functions for the mode of the MFP selected by the user and the extended functions related to the mode on one image of the touch-panel display.

### OTHER MODIFICATIONS

### First Example

In the process corresponding to S2200 of the embodiment and of the modification described above, the display data for displaying the extended functions is formed. In place of forming the display data, the display data (for example, HTML data) for displaying the extended functions on the touch-panel display of the MFP may be stored in the extended functions management table shown in FIG. 4, and the display data corresponding to the mode selected by the user may be read from the extended functions management table. By such an approach, it is possible to alleviate the load on the server computer for forming the display data.

### Second Example

When default setting is made in relation to mode selection in the MFP (for example, when the copy mode is set as the default mode), the image shown in FIG. 6 may be displayed on touch-panel display 380 before the user presses the “COPY” button. In that case, when display of the initial image is requested, information representing the copy mode as the default mode is transmitted from the MFP to the server computer as in the case when the copy mode is selected, and the display data for displaying the extended functions from the server computer is received by the MFP.

### Third Example

The following configuration may be possible by combining the embodiment above with the modification. An optional program as described in the modification may be transmitted from the server computer to the MFP, and the MFP may execute the received optional program on the API. By such an approach, even when the MFP does not transmit the scanned data to the server computer and the server computer does not receive the processed data from the MFP, the extended function or functions can be realized by executing the optional program transmitted from the server computer on the MFP. In this situation, though the server computer is necessary, the extended function or functions are executed by the MFP. The present invention may encompass any manner of realizing the extended functions.

### Fourth Example

In the embodiment and the modification, the standard functions and extended functions related to each other are displayed in one image on the touch-panel display, using the mode selected in the MFP. Though the related standard functions and extended functions are displayed through the mode above, the mode may not be used. By way of example, the standard functions may be classified to function-by-function categories, and relation between the extended functions and the categories are established. In this manner, the standard functions and extended functions related to each other can be displayed in one image on the touch-panel display with reference to the categories (not necessitating the modes).

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image forming apparatus for which a process by an extended function is prepared in addition to a standard function, comprising:
a display unit displaying information related to a function of said image forming apparatus; and
a control unit controlling said display unit such that when said standard function is displayed, an extended function related to said displayed standard function is displayed.

2. The image forming apparatus according to claim 1, further comprising
a selecting unit allowing a user to select one mode from a plurality of operation modes provided in said image forming apparatus; wherein
said control unit controls said display unit such that when a standard function for the selected mode is displayed, an extended function for the selected mode is displayed.

3. The image forming apparatus according to claim 1, wherein
said control unit displays a plurality of said standard functions in a manner allowing user selection, and
displays a plurality of said extended functions in a manner allowing user selection.

4. The image forming apparatus according to claim 1, further comprising
a communication unit for communication with an external apparatus; wherein
said extended function is realized by said external apparatus executing a program on data transmitted from said communication unit.

5. The image forming apparatus according to claim 4, wherein
said external apparatus processes data received from said image forming apparatus and transmits the processed data to said image forming apparatus; and
said extended function is realized by said image forming apparatus receiving said processed data from said external apparatus.

6. The image forming apparatus according to claim 4, wherein
said external apparatus processes data received from said image forming apparatus and transmits the processed data to an information processing apparatus other than said image forming apparatus; and
said extended function is realized by said information processing apparatus receiving said processed data from said external apparatus.

7. The image forming apparatus according to claim 1, wherein
an additional program is installed; and
said extended function is realized by said image forming apparatus executing the additional program.

8. The image forming apparatus according to claim 1, wherein said standard function is prepared to be realizable by said image forming apparatus at a stage of shipment of said image forming apparatus from a manufacturer of said image forming apparatus.

9. The image forming apparatus according to claim 1, wherein said extended function is prepared to be realizable by said image forming apparatus at a stage later than shipment of said image forming apparatus from a manufacturer of said image forming apparatus.

10. The image forming apparatus according to claim 1, wherein
said display unit includes a pressure-sensitive display divided beforehand to at least three areas including first, second and third areas, for displaying a pressure-sensitive selection button in each area; and
said control unit displays selection buttons allowing a user to select one mode from a plurality of operation modes provided in said image forming apparatus in said first area,
displays selection buttons allowing the user to select, in response to mode selection by the user in said first area, a standard function for said selected mode in said second area, and
displays selection buttons allowing the user to select, in response to mode selection by the user in said first area, an extended function for said selected mode in said third area.

11. The image forming apparatus according to claim 10, wherein said control unit displays, in response to selection of any of said standard functions and said extended functions by the user, a setting image for the selected function in a predetermined area of said pressure-sensitive display.

12. The image forming apparatus according to claim 10, wherein said control unit displays said selection buttons in the form of a hierarchical menu, in a predetermined area of said pressure-sensitive display.

13. A function display method for an image forming apparatus for which an extended function added to a standard function is prepared, and having a display unit, said method comprising the steps of
displaying information related to a function of said image forming apparatus on said display unit; and
displaying, when said standard function is displayed on said display unit, an extended function related to said displayed standard function on said display unit.

14. The function display method according to claim 13, wherein
said image forming apparatus further includes a selecting unit;
said method further comprising the step of detecting selection of one mode from a plurality of operation modes provided in said image forming apparatus through said selecting unit; wherein
at said step of displaying the extended function on said display unit, a standard function for said selected mode and an extended function for said selected mode are displayed.

15. The function display method according to claim 13, wherein at said step of displaying the extended function on said display unit, a plurality of said standard functions and a plurality of said extended functions are displayed in a manner allowing user selection.

16. The function display method according to claim 13, wherein
said image forming apparatus further includes a communication unit for communication with an external apparatus;
said method further comprising the step of transmitting information representing an extended function selected by the user and object data to be processed by the extended function to said external apparatus through said communication unit; and wherein
said extended function is realized by said external apparatus executing a program corresponding to said information on said object data.

17. The function display method according to claim 16, further comprising the step of receiving data generated by execution of said program on said object data, from said external apparatus.

18. The function display method according to claim 13, wherein
said image forming apparatus has an additional program installed;
said method further comprising the step of realizing said extended function by executing said additional program.

19. The function display method according to claim 13, wherein
said standard function is prepared to be realizable by said image forming apparatus at a stage of shipment of said image forming apparatus from a manufacturer of said image forming apparatus; or
said extended function is prepared to be realizable by said image forming apparatus at a stage later than shipment of said image forming apparatus from a manufacturer of said image forming apparatus.

20. The function display method according to claim 13, wherein
said display unit includes a pressure-sensitive display divided beforehand to at least three areas including first, second and third areas, for displaying a pressure-sensitive selection button in each area;
said method further comprising the steps of;
displaying selection buttons allowing a user to select one mode from a plurality of operation modes provided in said image forming apparatus in said first area;
displaying selection buttons allowing the user to select, in response to mode selection by the user in said first area, a standard function for said selected mode in said second area; and
displaying selection buttons allowing the user to select, in response to mode selection by the user in said first area, an extended function for said selected mode in said third area.
